(19) United States
(12) Patent Application Publication
(10) Pub. No.: US 2007/0288119 A1
(43) Pub. Date: Dec. 13, 2007

(54) Automatic Data Configuration Strategy, Such as For Storing and Manipulating Product Manufacturing Data

(75) Inventor: Anthony P. Wright, Kirkland, WA (US)

Correspondence Address: PERKINS COIE, LLP, P.O. BOX 1247, PATENT - SEA, SEATT;E, WA, 98111-1247, US

(73) Assignee: The Boeing Company, Chicago, IL (US)

(21) Appl. No.: 11/841,314

(22) Filed: Aug. 20, 2007

Related U.S. Application Data
(62) Division of application No. 11/078,217, filed on Mar. 11, 2005.

(51) Int. Cl. G06F 19/00

(52) U.S. Cl. 700/182

(57) ABSTRACT

Managing product design and specification information in accordance with the invention may include receiving input information providing design data for a product comprising a collection of parts. The input information may be published into a computer aided design environment. In addition, processing may take place to allow for classifying aspects of the input information. Based on this classification, further processing may be performed, and may include parsing the published input information to generate separate part files that can be individually accessed and/or modified. The part files and the converted input information may be stored in a data storage environment or directly accessed for use in the computer aided design environment.

### TECHNICAL FIELD

The present invention relates generally to methods and systems for managing information, such as information created using software packages configured for computer aided design, computer aided engineering, and/or computer aided manufacturing.

### BACKGROUND

Manufacturing complex products, such as airplanes, often involves creating and storing large amounts of design and specification data. This design and specification data typically defines entire products, as well as individual parts and processes associated building complex products. Manufacturing companies typically employ computer software packages to help create, retain, and manipulate this design and specification data. An example of such a software package is CATIA, by Dassault Systemes S.A., of France. CATIA is an integrated suite of computer aided design (CAD), computer aided engineering (CAE), and computer aided manufacturing (CAM) applications for product definition and simulation. In general, software packages like CATIA allow manufacturers to facilitate industrial design processes from the pre-project phase through detailed design, analysis, simulation, assembly, and maintenance.

Software packages such as CATIA may integrate other applications to facilitate and manage storage and retrieval of design and specification data after it is initially created. An example of such an application is ENOVIA.

In some cases, aspects of the same design and specification data can be used across multiple products. For example, two different airplanes may share many of the same parts. In other cases, aspects of the same design and specification data may be modified to easily create design and specification data for new products and parts. Accordingly, one advantage associated with storing design and specification data in a data storage and management application such as ENOVIA is that it facilitates long term storage and reuse of such data. In this way, designers can easily modify existing products, design new products (e.g., derivative design), and create manufacturing simulations. For example, when setting out to create a new product or part, a design engineer may retrieve stored specification and design data from the data storage and management application. The design engineer can then modify, assemble, and otherwise apply the retrieved information as necessary to define the desired new product or part.

Most data storage and management applications such as ENOVIA have their own requirements as to the way that data is to be configured for storage and management. For example, ENOVIA requirements may specify a file format that enables the rapid parsing of design and specification data down to the part level. While configuration requirements like these are to be expected with almost any type of software, compatibility issues may be an issue. In such cases, system users may be faced with reconfiguring incompatible files. However, reconfiguring data in this way is not always easy and typically involves manual manipulation of the data prior to storage.

Matters are complicated even further when the files destined for storage are initially generated using an out-of-date version of the CAD/CAE/CAM environment. For example, if a CATIA V4 model is used directly in CATIA V5 without being converted, it is treated as having all of its parts lumped together, which may be inconsistent with ENOVIA. To illustrate, an airplane definition in the form of a single CATIA V4 model that is used CATIA V5 has geometry data for all its parts lumped into a single part model that is generally not compatible with the ENOVIA configuration requirements.

To avoid incompatibility with the ENOVIA system but still allow compatibility within CATIA V5, current techniques for configuring information stored in CATIA V4 files for storage in ENOVIA typically include relying on human designers and configuration engineers to manually parse the V4 part model into separate V5 part models on an as needed basis (as opposed to using currently available automatic V5 conversion techniques). While they preserve the usefulness of information in the CATIA V5 environment and allow for storage in ENOVIA, such manual parsing techniques can be time consuming and expensive, as well as error prone, especially in the area of maintaining relationships between product parts that have been separated out from one another using such manual parsing techniques.

### SUMMARY

The present invention is directed toward a computer-implemented facility for managing product design and specification information. In some embodiments of the invention, this may include the manipulation of information in a computer aided design environment (e.g., a CAD/CAE/CAM system) such that the information can be more readily manageable in the computer aided design environment and in other related environments. For example, after manipulation of the data, it may be more readily stored in and accessed from a data storage/management facility (e.g., ENOVIA) or otherwise used by designers to develop new products, modify existing product designs, run product simulations, etc.

In some embodiments, a method of managing product design and specification information may be employed that includes receiving input information (e.g., design information for a product comprising one or more parts). For example, this input information may include part instance name information and part number information for each part of the product. At least some of the input information may then be published in a computer aided design environment so that it can be configured accordance with the invention.

The publication may sometimes include classifying the input information so that it can be associated into one or more distinct part output files during further processing. An example of such further processing may include parsing the published information to extract one or more part entities that each correspond to a part. The processing may further include subsequently generating, for each part entity, an output file that contains attributes including the definition of a single part or, in some cases, assemblies comprising multiple parts. The output files may then be stored in a data storage environment or otherwise used in the computer aided design system, or in another system. In some embodiments, the generated part output file is configured so that its attributes can be modified. The generated part output file may also be stored in a data storage environment (e.g., ENOVIA) and/or associated with a detailed product structure.

In some embodiments, the input information may be generated, at least in part, using a first version of the computer aided design environment, but other sources for input information are also possible. Regardless of the source, classifying the input information may include separating information of the input file into layers or classifications, wherein each of the layers or classifications may be associated with at least one geometric object defining a part of the product. In some embodiments, classifying the input information may be performed, at least in part, by a user.

In some embodiments, implementation occurs via a system configured for the management of product design and specification information. For example, the system may include a computer aided design environment configured for the creation and manipulation of the product design information that includes geometric part information for defining part that comprise a product. The system may also include a publishing component configured for publishing input information in the computer aided design environment, wherein the input information includes the product design information. In addition, the system may include a breakdown component configured for generating one or more distinct part files based on the published information.

### BRIEF DESCRIPTION OF THE DRAWINGS

FIG. 1 is a block diagram illustrating a representative environment for practicing an embodiment of the invention.

FIG. 2 is a block diagram illustrating another representative environment for practicing an embodiment of the invention.

FIG. 3 is a flow diagram illustrating an example of a routine for publishing information from an input file containing product and/or part information to a CAD/CAM/CAE environment in an embodiment of the invention.

FIG. 4 is a flow diagram illustrating an example of a routine for parsing information of the published information of FIG. 3 into a desired format.

FIG. 5 is a flow diagram illustrating an example of a routine for converting information in an input file generated using an earlier version of a CAD/CAEICAM environment into a collection of files that are compatible with a newer version of a CAD/CAM/CAE environment in an embodiment of the invention.

### DETAILED DESCRIPTION

The following disclosure describes systems, methods, and formats for facilitating the manipulation of product design and specification information in accordance with a collection of software applications used in the creation, management, and storage of the design and specification information.

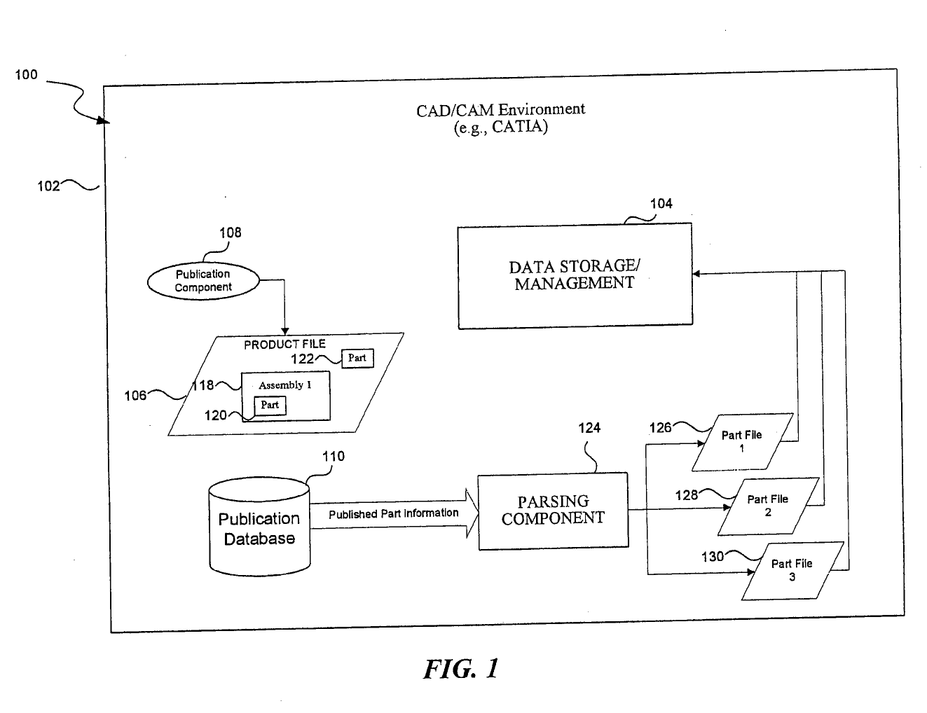

Certain specific details are set forth in the following description and in FIGS. 1-5 to provide a thorough understanding of various embodiments of the invention. Well-known structures, systems and methods often associated with computer aided design/computer aided engineering/computer aided manufacturing (CAD/CAE/CAM) environments have not been shown or described in detail to avoid unnecessarily obscuring the description of the various embodiments of the invention. Those of ordinary skill in the relevant art will understand that additional embodiments of the present invention may be practiced without several of the details described below.

Many embodiments of the invention described below may take the form of computer-executable instructions, including routines executed by a programmable computer (e.g., a computer-controlled design process). Those skilled in the relevant art will appreciate that the invention can be practiced with other computer system configurations as well. The invention can be embodied in a special-purpose computer or data processor that is specifically programmed, configured, or constructed to perform one or more of the computer-executable instructions described below. Accordingly, the term “computer” as generally used herein refers to any data processor and includes Internet appliances, hand-held devices (including palm-top computers, wearable computers, cellular or mobile phones, multi-processor systems, processor-based or programmable consumer electronics, network computers, minicomputers and the like).

The invention can also be practiced in distributed computing environments, where tasks or modules are performed by remote processing devices that are linked through a communications network. In a distributed computing environment, program modules or subroutines may be located in both local and remote memory storage devices. Aspects of the invention described below may be stored or distributed on computer-readable media, including magnetic and optically readable and removable computer disks, as well as distributed electronically over networks. Data structures and transmissions of data particular to aspects of the invention are also encompassed within the scope of the invention.

I. Representative Environments

FIG. 1 is a block diagram illustrating a representative environment 100 for practicing an embodiment of the invention. The representative environment 100 may be implemented using one or more computers, such as a single computer, or computers on a network (e.g., a local area network (LAN) or other network) consisting of one or more processors, memory, hard drives, input/output features, operating systems, graphics features, etc., (not illustrated to maintain clarity in the Figures, and because they are well known in the art).

The representative environment 100 may include a CAD/CAE/CAM environment 102. While a number of CAD/CAE/CAM environments are available and may be used to implement the invention, an illustrative example of such a CAD/CAE/CAM environment is CATIA V5, by Dassault Systemes S.A., of France. The representative environment 100 may also include a data storage/management facility 104 such as ENOVIA. The data storage/management facility 104 may be in communication with the CAD/CAE/CAM environment 102 or may be incorporated therein. For example, the data storage/management facility 104 may store design and specification data generated using the CAD/CAE/CAM environment 102 to facilitate efficient organization and access to such information.

In some embodiments, some versions of the CAD/CAE/CAM environment 102 may define a product (e.g., made up of parts and/or assemblies) using a product file 106 containing an aggregation of part definitions. An example of such a file is a Microsoft Excel file containing part instance name and part number information. While such files may be used in many ways, in some circumstances, it may be more practical/desirable to store and/or manipulate the data from the file 106 into another format. Accordingly, the representative environment 100 may include a combination of components that can be to manipulate the data from the file 106 in various ways.

In some embodiments, the manipulation of the data takes place in a particular version of the CAD/CAE/CAM environment 102, such as CATIA V5. Accordingly, the manipulation of the data from the file 106 may begin by publishing the information from the file 106 using a publication component 108. In some embodiments, the publication component 108 stores the published information in a publication database, where it may be accessed by various users via interfaces of the CAD/CAE/CAM environment 102. In some embodiments, the publication component is configured to preserve information about the relationship of various assemblies 118 and parts (120 and 122) making up the product. A parsing component 124 may then be used to extract part information from the published file information and reconfigure it into separately accessible parts files (126, 128, and 130), which can be stored and otherwise managed using the CAD/CAE/CAM environment and/or the data storage/management facility 104.

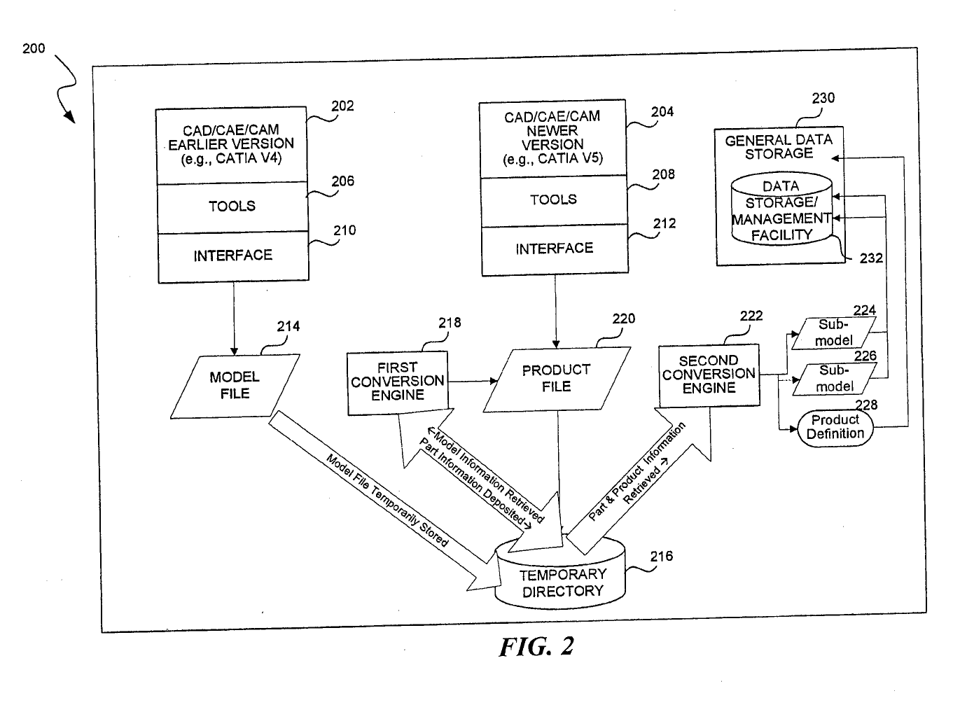

FIG. 2 is a block diagram illustrating another representative environment 200 for practicing an embodiment of the invention. The representative environment 200 may be implemented using one or more computers, such as a single computer, or computers on a network (e.g., a local area network (LAN) or other network) consisting of one or more processors, memory, hard drives, input/output features, operating systems, graphics features, etc., (not illustrated to maintain clarity in the Figures, and because they are well known in the art).

The representative environment 200 may include two or more separate versions of a CAD/CAE/CAM environment, such as an earlier version 202 (e.g., CATIA V4) and a newer version 204 (e.g., CATIA V5), each with its own set of tools (206 and 208) and application programming interfaces (APIs) (210 and 212). For example, the representative environment 200 may be implemented on an UNIX machine that has both CATIA V4 and CATIA V5 installed.

The representative environment 200 of the illustrated embodiment shows a model file 214 created using the earlier version of the CADICAE/CAM environment. The model file 214 may define a single product (made up of one or more parts) and may contain design and specification information for the product. However, the model file 214 may be initially configured such that it cannot be easily stored and manipulated as desired. Accordingly, the representative environment 200 may include one or more components that allow the information in the model file 214 to be formatted so that it can be compatible with the newer version of the CAD/CAE/CAM environment 204 and/or so that it can be stored and managed using a data storage and management facility. For example, the model file may be stored in a temporary directory 216 so that it can be accessed/retrieved by a first conversion engine 218. The first conversion engine 218 may then create multiple part entities (not show) based on the model file 214 and deposit them in the temporary directory 216. In addition, the first conversion engine 218 may create a product file 222 that is compatible with the newer version of the CAD/CAE/CAM environment 204. A second conversion engine 222 may then take the part entity information from the temporary directory 216 and combine it with information from the new product file 222 to create various part sub-models (224 and 226) that can be stored in a general data storage 230, along with product definition information 228 that defines the sub-models with respect to each other. More specifically, the parts/products database 230 may include a data managemenustorage facility 232 such as ENOVIA, in which the sub-models (224 and 226) may be stored. The data storage/management facility 232 may be in communication with both the earlier version 202 and the newer version 204 of the CAD/CAE/CAM environment. It may also include its own user interface (not shown).

In some embodiments, where the earlier version of the CAD/CAEICAM environment 202 is based on a CATIA ditto/detail workspace configuration, each of the sub-models (224 and 226) may represent a workspace of the original model. The resulting product 222 file may then include a reference the individual sub-models (224 and 226), allowing an instance of each of the sub-models to be instantiated when the information in the product file 222 is accessed. In some cases, the product file can be referenced directly by the newer version of the CAD/CAE/CAM environment 204 or loaded into the data storage/management facility 214. In either case, the product file can be used as a context for new design, manufacturing simulation, design reviews, etc.

II. Representative Flows

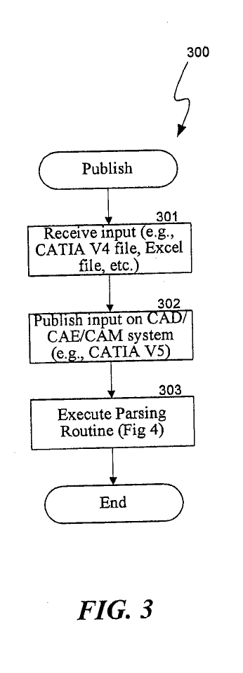

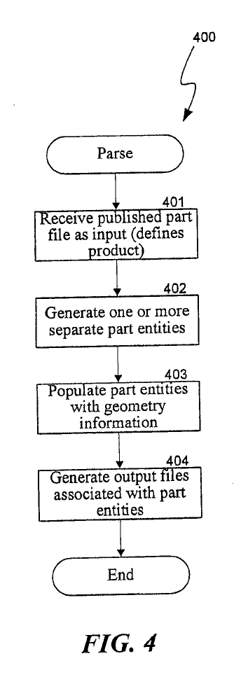

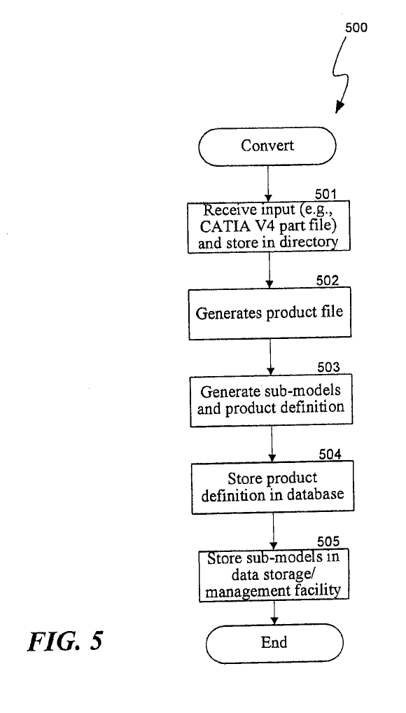

Methods for converting data in each of the foregoing embodiments are described with reference to FIGS. 3-5 below. FIGS. 3 and 4 illustrate an embodiment of one or more routines associated with the environment shown in FIG. 1. FIG. 5 illustrates one or more routines associated with the environment shown in FIG. 2. In other arrangements, these methods may be practiced in other environments, including the environments shown in FIGS. 2 and 1, respectively

FIG. 3 is a routine 300 for publishing product information (including part information) to a designated version of a CAD/CAE/CAM environment (e.g., converting information from CATIA V4 to CATIA V5) so that the product information can be reconfigured into a desired format. For example, this routine 300 may be practiced in the representative environment 100 of FIG. 1. In some embodiments, the routine 300 generates information used as input for a parsing routine, such as the parsing routine 400 described with respect to FIG. 4 below.

At block 301 the routine 300 receives input information that may define a product made up of one or more parts (e.g., a part on an airplane). For example, this input information may comprise at least one part or product model file generated by a design engineer using a tool associated with the CAD/CAM/CAE environment (e.g., a CATIA V4 file, an Excel file, etc.). At block 302, the routine 300 publishes information from the received input information in a version of the CA/CAM/CAE environment (e.g., CATIA V5). For example, the routine 300 may extract part instance name (e.g., wing nut 5) and part number information (e.g., 151) for each part associated with the product defined by the input information. At block 303, the routine 300 executes a parsing routine on the published information. In some cases, a user may initiate the execution of the parsing routine. Additional details associated with the parsing routine are described with respect to FIG. 4.

Referring to FIG. 4, a parsing routine 400 may be executed to break down the published information into a set of distinct part files configured using a desired format. For example, the distinct part files may be configured such that the persistent storage environment, as well as the new version of the CAD/CAE/CAM environment, can easily handle them.

At block 401 the parsing routine 400 may receive the published information as input. At block 402, the parsing routine 400 generates one or more separate part entities (e.g., part objects) based on the published information. At block 403, the parsing routine 300 populates each of the separate part entities with geometry as defined by the published information. At block 404 the parsing routine 400 generates one or more output files, with each of the one or more output files including information associated with the separate part entities. For example, in an object oriented programming scheme each of the output file may include an instance of one of the part entities as defined with respect to block 403 of the parsing routine 400.

The part files output by the parsing routine 400 may then be stored in the persistent storage environment, from where they may be individually associated into a detailed product structure. For example, they may be individually used to reconstruct a complete model of the original product (e.g., airplane) or arranged in various combinations to reconstruct a new product. In addition, in some embodiments, the part model files may be copied and then modified to create new parts and products.

FIG. 5 is a routine 500 for converting files generated using an earlier version of a CAD/CAEICAM environment, into files compatible with a new version of the CAD/CAEICAM environment (e.g., converting information from CATIA V4 to CATIA V5) in accordance with an embodiment of the invention. For example, this routine 500 may be practiced in the representative environment 200 of FIG. 2.

At block 501 the routine 500 receives an input model file generated using a first version of a CAD/CAE/CAM environment (e.g., CATIA V4), which is stored in a temporary directory. For example, the input model file may define a single product (e.g., made up of multiple parts). At block 502 the routine 500 generates a product file that is compatible with a second version of the CAD/CAE/CAM environment (e.g., CATIA V5). In some cases, the product file can be stored and accessed via the newer version of the CAD/CAE/CAM environment. At block 503, based on information in the generated product file and in the initial input model file (e.g., as stored in the temporary directory), the routine 500 generates a product definition and one or more sub-models, which each correspond to a part or assembly (a grouping of multiple parts) in the input model file. The product definition may define the relationship between the sub-models. In some embodiments where the first version of the CAD/CAEICAM environment is based on a CATIA ditto/detail workspace configuration, each of the sub-models may represent a workspace of the original model.

At block 504, the routine stores the generated product definition in a database or other depository. At block 505, the routine stores the generated sub-models in a data storage/management environment, such as ENOVIA. In some embodiments, the data storage/management environment may reside, at least in part, in the data base or other depository in which the product definition is stored. This storage configuration may allow an instance of each of the sub-models to be instantiated when the information in the product file is accessed (e.g., in the context of generating a new design, manufacturing simulation, design reviews, etc.).

From the foregoing, it will be appreciated that specific embodiments of the invention have been described herein for purposes of illustration, but that various modifications may be made without deviating from the spirit and scope of the invention and aspects of the invention described in the context of particular embodiments may be combined or eliminated in other embodiments. For example, while certain embodiments describe the use of “earlier” and “newer” versions of a CAD/CAE/CAM environment, the invention may be implemented using other variations of a CAD/CAE/CAM environment. Although advantages associated with certain embodiments of the invention have been described in the context of those embodiments, other embodiments may also exhibit such advantages. Additionally, none of the foregoing embodiments need necessarily exhibit such advantages to fall within the scope of the invention. Accordingly, the invention is not limited except as by the appended claims.

1-24. (canceled)

25. A method for configuring data entities that define products and parts for use within one or more versions of a computer aided design environment, the method comprising:
receiving an input entity, wherein the input entity provides an aggregation of design information for a product comprising one or more parts, and wherein the input entity is compatible with a first version of the computer aided design environment but not with a second version of the computer aided design environment;
generating a product output entity that is compatible with the second version of the computer aided design environment, wherein the product output entity includes an indication of at least some of the design information in the input entity;
generating one or more part sub-entities based on information in the input entity and based on the product output entity;
generating a product definition entity, wherein the product definition entity provides an indication of relationships that exist among the one or more part sub-entities, wherein an instance of the product definition entity and an instance of each of the one or more part sub-entities are created when the product output entity is accessed in the second version of the computer aided design environment; and
storing at least one of the generated product output entity, the generated on or more part sub-entities, and the product definition entity on a computer-readable medium.

26. The method of claim 25
wherein the first version of the computer aided design environment includes CATIA V4,
wherein the second version of the computer aided design environment includes CATIA V5,
wherein the product is defined based on part geometry information for the one or more parts,
wherein at least some of the one or more parts are arranged into one or more assemblies that each include multiple parts,
wherein each of the one or more part sub-entities corresponds to at least one of the one or more parts or at least one of the one or more assemblies, and
wherein the earlier version of the computer aided design environment is based on a CATIA ditto/detail user interface workspace configuration, wherein each of the sub-entities corresponds to a distinct user interface workspace of the original model.

27. The method of claim 25, further comprising:
storing each of the one or more part sub-entities in a data storage environment; and
storing the product definition entity in the data storage environment.

28. The method of claim 25, further comprising:
storing the one or more part sub-entities in a data storage environment; and
storing the product definition entity outside the data storage environment.

29. The method of claim 25, further comprising:
instantiating an instance of each of the one or more part sub-entities each time the product output entity is accessed via the second version of the computer aided design environment; and
loading the product output entity into the second version of the computer aided design environment for subsequent use or for use in creating a new design based on the product, facilitating a manufacturing simulation of the product, or reviewing a design of the product.

30. The method of claim 25 wherein the product is defined by defining geometry for one or more parts and defining the relationship between the one or more parts, and wherein each of the one or more part sub-entities corresponds to at least one of the one or more parts.

31. The method of claim 25 wherein the first version of the computer aided design environment includes CATIA V4 and wherein the second version of the computer aided design environment includes CATIA V5.

32. The method of claim 25 wherein the product is defined by specifying one or more parts and the relationship between the one or more parts.

33. The method of claim 25 wherein the product is defined by specifying one or more parts and one or more assemblies, and wherein each of the assemblies includes an arrangement of parts.

34. The method of claim 25 wherein the earlier version of the computer aided design environment is based on a CATIA ditto/detail user interface workspace configuration, wherein each of the part sub-entities corresponds to a distinct user interface workspace associated with the input entity.

35. The method of claim 25, further comprising loading the output entity into a storage environment for subsequent use.

36. The method of claim 25, further comprising loading the product output entity into the computer aided design environment for use in creating a new design based on the product.

37. The method of claim 25, further comprising loading the product output entity into the computer aided design environment for use in a manufacturing simulation of the product.

38. The method of claim 25, further comprising loading the product output entity into the computer aided design environment for use in reviewing the product design.

39. The method of claim 25 wherein the product output entity is generated using a first conversion engine and wherein the one or more part sub-entities and the product definition entity are generated using a second conversion engine.

40. A system for configuring data entities so that they are more compatible with a computer aided design environment, the system comprising:
a first version of a computer aided design environment, wherein the computer aided design environment is configured for the creation and manipulation of the product design information;
a second version of the computer aided design environment;
at least one conversion engine configured for
converting information obtained from an input entity created using the first version of the computer aided design environment into multiple output entities that are each configured for individual and aggregate use within the second version the computer aided design environment, wherein each of the multiple output entities corresponds to a part associated with a product defined by the input entity, and
extracting parts relationship information obtained from the input entity, wherein the parts relationship information defines relationships among parts associated with the product defined by the input entity;
creating a product file for use in the second version of the computer aided design environment, wherein the product file is created at least in part, based on the input entity, and wherein the product file cannot be used in the second version of the computer-aided without reference to the parts relationship information and the multiple output entities; and
at least one storage facility for storing the multiple output entities on a computer readable medium.

41. The system of claim 40, further comprising a temporary directory for storing information for use by the conversion engine.

42. The system of claim 40 wherein the first version of the computer aided design environment includes CATIA V4 and wherein the second version of the computer aided design environment includes CATIA V5.

43. The system of claim 40 wherein the first version of the computer aided design environment includes a first set of tools, wherein the second version of the computer aided design environment includes a second set of tools; and wherein at least some of the second set of tools are not compatible with information entities generated using the first version of the computer aided design environment.

44. The system of claim 40 wherein the first version of the computer aided design environment includes a first set of application programmer interfaces (APIs), wherein the second version of the computer aided design environment includes a second set of application programmer interfaces (APIs), and wherein at least some of the second set of application programmer interfaces (APIs) are not compatible with information entities generated using the first version of the computer aided design environment.

45. The system of claim 40 wherein the at least one storage facility is a component of a data storage/management facility in which the multiple output entities are stored, wherein the data storage/management facility is in communication with both the first version of the computer aided design environment and the second version of the computer aided design environment.

46. The system of claim 40, wherein the at least one conversion engine includes:
a first conversion engine configured for generating the product file;
a second conversion engine configured for generating the multiple output entities and the parts relationship information; and
wherein the the multiple output entities and the parts relationship information are based, at least in part, on the generated product file.

47. A computer-readable medium on which a data structure is stored, the stored data structure comprising:
a reference to multiple part entities associated with product information defining a product that is retrieved from a first product model file generated using a first version of a computer aided design environment, wherein each of the multiple part entities corresponds to a part or assembly comprising the product;
an indication of the relationship among the multiple part entities; and
wherein the data structure is configured to facilitate the access, use, and/or modification of a second product model file related to the product, wherein the second product model file is generated based on the first product model file and is for use within a second version of the computer aided design environment.

48. The computer-readable medium of claim 47, wherein the multiple part entities are generated by automatically parsing the product information to extract one or more part entities.
